(19) United States
(12) Patent Application Publication
(10) Pub. No.: US 2021/0365696 A1
(43) Pub. Date: Nov. 25, 2021

(54) Vehicle Intelligent Driving Control Method and Device and Storage Medium

(71) Applicant: Shenzhen Sensetime Technology Co., Ltd., Shenzhen (CN)

(72) Inventors: Yuan He, Shenzhen (CN); Haibo Zhu, Shenzhen (CN); Ningyuan Mao, Shenzhen (CN)

(73) Assignee: Shenzhen Sensetime Technology Co., Ltd., Shenzhen (CN)

(21) Appl. No.: 17/398,686

(22) Filed: Aug. 10, 2021

Related U.S. Application Data
(63) Continuation of application No. PCT/CN2019/076441, filed on Feb. 28, 2019.

(51) Int. Cl. G06K 9/00; G06T 7/12; G06T 7/70; B60W 30/095; B60W 50/14

(52) U.S. Cl. CPC G06K 9/00798; G06K 9/00825; G06T 7/12; G06T 7/70; G06K 2209/15; B60W 50/14; G06T 2207/30252; G06T 2210/12; B60W 30/095

(57) ABSTRACT

The present disclosure relates to a method, a device, and a storage medium for vehicle intelligent driving control. The vehicle intelligent driving control method comprises: collecting, by means of a vehicle-mounted camera of a vehicle, a video stream of a road image of a scene where the vehicle is; detecting a target object in the road image to obtain a bounding box of the target object; determining, in the road image, a free space for the vehicle; adjusting the bounding box of the target object according to the free space; and carrying out intelligent driving control on the vehicle according to the adjusted bounding box. The bounding box of the target object can be used to identify the position and determine the actual position of the target object more precisely, such that intelligent driving control can be carried out on the vehicle more accurately.

### CROSS-REFERENCE TO RELATED APPLICATION

The present disclosure is a continuation of and claims priority under 35 U.S.C. 120 to PCT application No. PCT/CN2019/076441 filed on Feb. 28, 2019. All the above referenced priority document is incorporated herein by reference in its entirety.

### TECHNICAL FIELD

The present disclosure relates to the technical field of image processing, in particular to a vehicle intelligent driving control method and device, an electronic apparatus, and a storage medium.

### BACKGROUND

On the road, a camera mounted on a vehicle may be used to capture road information to perform distance measurement, so as to fulfill functions such as automatic driving or assistant driving. On the road, vehicles are crowded and badly occlude one another. As a result, the vehicle position identified by a bounding box of the vehicle deviates greatly from the actual position, which causes conventional distance measuring methods become inaccurate.

### SUMMARY

The present disclosure proposes a technical solution of vehicle intelligent driving control.

According to one aspect of the present disclosure, there is provided a vehicle intelligent driving control method, comprising:

collecting, by a vehicle-mounted camera of a vehicle, a video stream of a road image of a scenario where the vehicle is located;

detecting a target object in the road image to obtain a bounding box of the target object; and determining, in the road image, a free space of the vehicle;

adjusting the bounding box of the target object according to the free space; and

performing intelligent driving control on the vehicle according to an adjusted bounding box.

According to one aspect of the present disclosure, there is provided a vehicle intelligent driving control device, comprising:

a video stream acquiring module, configured to collect, by a vehicle-mounted camera of a vehicle, a video stream of a road image of a scenario where the vehicle is located;

a free space determining module, configured to detect a target object in the road image to obtain a bounding box of the target object; and determine, in the road image, a free space of the vehicle;

a bounding box adjusting module, configured to adjust the bounding box of the target object according to the free space; and

a control module, configured to perform intelligent driving control on the vehicle according to an adjusted bounding box.

According to one aspect of the present disclosure, there is provided an electronic apparatus, comprising:

a processor; and

a memory configured to store processor-executable instructions,

wherein the processor is configured to execute the method according to any one of the above-mentioned items.

According to one aspect of the present disclosure, there is provided a computer readable storage medium having computer program instructions stored thereon, wherein the computer program instructions, when executed by a processor, implement the method according to any one of the above-mentioned items.

In the embodiments of the present disclosure, a video stream of a road image of a scenario where the vehicle is located is collected by a vehicle-mounted camera of a vehicle; a target object is detected in the road image to obtain a bounding box of the target object; a free space of the vehicle is determined in the road image; the bounding box of the target object is adjusted according to the free space; and intelligent driving control is performed on the vehicle according to an adjusted bounding box. The bounding box of the target object, adjusted according to the free space, may identify the position of the target object more accurately, and may be used to determine the actual position of the target object more accurately, so as to perform the intelligent driving control of the vehicle more precisely.

It should be understood that the general description above and the following detailed description are merely exemplary and explanatory, instead of restricting the present disclosure. Additional features and aspects of the present disclosure will become apparent from the following detailed description of exemplary embodiments with reference to the attached drawings.

### BRIEF DESCRIPTION OF THE DRAWINGS

The drawings herein, which are incorporated in and constitute part of the specification, illustrate embodiments in line with the present disclosure, and serve to explain the technical solutions of the present disclosure together with the specification.

FIG. 1 shows a flow chart of a vehicle intelligent driving control method according to an embodiment of the present disclosure.

FIG. 2 shows a schematic diagram of a free space on the road in the vehicle intelligent driving control method according to an embodiment of the present disclosure.

FIG. 3 shows a flow chart of step S20 in the vehicle intelligent driving control method according to an embodiment of the present disclosure.

FIG. 4 shows a flow chart of step S20 in the vehicle intelligent driving control method according to an embodiment of the present disclosure.

FIG. 5 shows a flow chart of step S30 in the vehicle intelligent driving control method according to an embodiment of the present disclosure.

FIG. 6 shows a flow chart of step S40 in the vehicle intelligent driving control method according to an embodiment of the present disclosure.

FIG. 7 shows a flow chart of the vehicle intelligent driving control method according to an embodiment of the present disclosure.

FIG. 8 shows a block diagram of a vehicle intelligent driving control device according to an embodiment of the present disclosure.

FIG. 9 shows a block diagram of an electronic apparatus according to an exemplary embodiment of the present disclosure.

FIG. 10 shows a block diagram of an electronic apparatus according to an exemplary embodiment of the present disclosure.

### DETAILED DESCRIPTION

Various exemplary embodiments, features and aspects of the present disclosure will be described in detail with reference to the drawings. The same reference numerals in the drawings represent parts having the same or similar functions. Although various aspects of the embodiments are shown in the drawings, it is unnecessary to proportionally draw the drawings unless otherwise specified.

Herein the specific term “exemplary” means “used as an example, or embodiment, or explanatory”. Any embodiment described here as “exemplary” is not necessarily construed as being superior to or better than other embodiments.

The term “and/or” used herein represents only an association relationship for describing associated objects, and represents three possible relationships. For example, A and/or B may represent the following three cases: A exists alone, both A and B exist, and B exists alone. In addition, the term “at least one” used herein indicates any one of multiple listed items or any combination of at least two of multiple listed items. For example, including at least one of A, B, or C may indicate including any one or more elements selected from the group consisting of A, B, and C.

In addition, numerous details are given in the following specific embodiments for the purpose of better explaining the present disclosure. It should be understood by a person skilled in the art that the present disclosure can still be realized even without some of those details. In some of the examples, methods, means, elements and circuits that are well known to a person skilled in the art are not described in detail so that the spirit of the present disclosure becomes apparent.

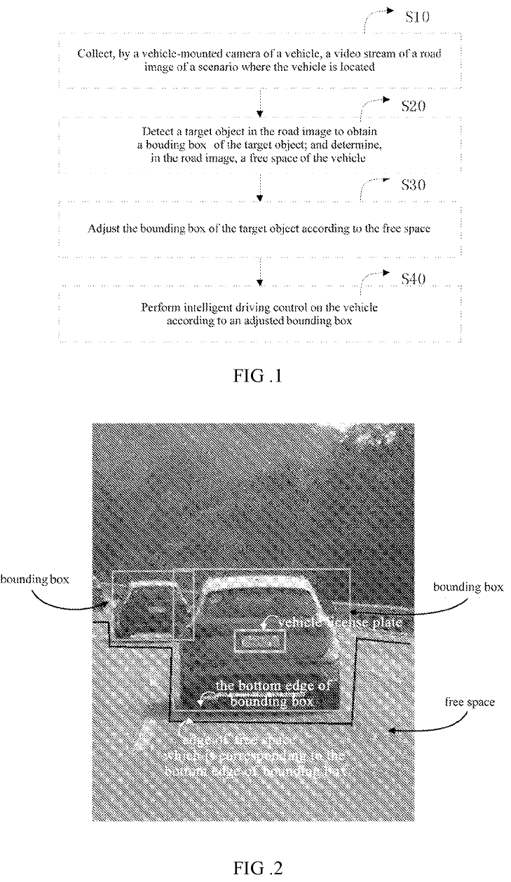

FIG. 1 shows a flow chart of a vehicle intelligent driving control method according to an embodiment of the present disclosure. As shown in FIG. 1, the vehicle intelligent driving control method comprises:

Step S10: collecting, by a vehicle-mounted camera of a vehicle, a video stream of a road image of a scenario where the vehicle is located.

In a possible implementation, the vehicle may be a manned vehicle, a cargo vehicle, a toy vehicle, a driverless vehicle, etc. in reality. It may also be a movable object, such as a vehicle-like robot or a racing vehicle, in the virtual scenario. A vehicle-mounted camera may be arranged on the vehicle. For a vehicle in reality, the vehicle-mounted camera may be various image-capturing vision sensors such as a monocular camera, an RGB camera, an infrared camera, and a binocular camera. Depending upon demands, environment, a type of current object, costs and the like, different capturing apparatus may be selected, which is not limited in the present disclosure. For a vehicle in a virtual environment, the corresponding functions of the vehicle-mounted camera may be provided on a vehicle to obtain a road image of the environment where the vehicle is located. This is not limited in the present disclosure. The road in the scenario where the vehicle is located may include various types of roads, e.g., urban roads, country roads, etc. The video stream captured by the vehicle-mounted camera may include video streams of arbitrary time lengths.

Step S20: detecting a target object in the road image to obtain a bounding box of the target object; and determining, in the road image, a free space of the vehicle.

In a possible implementation, the target object includes different types of objects, e.g., vehicles, pedestrians, buildings, obstacles, animals, etc. The target object may be a single or a plurality of target objects of one type of object, or may be a plurality of target objects of a plurality of types of objects. For example, it is possible to regard only a vehicle as the target object, and the target object may be one vehicle or a plurality of vehicles. It is also possible to regard both vehicles and pedestrians as the target objects. The target objects are a plurality of vehicles and a plurality of pedestrians. According to demands, a given type of object may be used as the target object, or a given object individual may be used as the target object.

In a possible implementation, an image detection technology may be adopted to acquire a bounding box of the target object in the image captured by the vehicle-mounted camera. The bounding box may be a rectangular box, or a box in another shape. The size of the bounding box may be varied according to the size of the image area covered by the target object in the image. For example, the target object in the image includes three motor vehicles and two pedestrians. By means of the image detection technology, the target objects can be identified by five bounding boxes in the image.

In a possible implementation, the free space may include unoccupied areas available for vehicles to travel on the road. For example, there are three motor vehicles on the road in front of the vehicle, and the area, unoccupied by the three motor vehicles, on the road is the free space. Sample images labelled with free spaces on the road may be used to train a neural network model of the free space. Road images may be input to the trained neural network model of the free space for processing, to obtain the free spaces in the road images.

FIG. 2 shows a schematic diagram of the free space on the road in the vehicle intelligent driving control method according to an embodiment of the present disclosure. As shown in FIG. 2, in the road image captured by the vehicle, there are two cars in front of the vehicle. The two white rectangular boxes shown in FIG. 2 are bounding boxes of the cars. The area below the black line segment shown in FIG. 2 is the free space of the vehicle.

In a possible implementation, one or more free spaces may be determined in the road image. It is possible to determine a free space on the road without discriminating different lanes. It is also possible to discriminate lanes, and determine free spaces on the lanes respectively, to obtain a plurality of free spaces. The free space shown in FIG. 2 is obtained without discriminating lanes.

Step S30: adjusting the bounding box of the target object according to the free space.

In a possible implementation, the accuracy of the actual position of the target object is of vital importance to the intelligent driving control of the vehicle. There are a large number of various target objects such as vehicles and pedestrians on the road, and the target objects are apt to occlude one another, resulting in a deviation between the bounding box of the obscured target object and the actual position of the target object. In a case that the target object is not occluded, the bounding box of the target object may also deviate from the actual position of the target object as a result of the detection algorithm or the like. The position of the bounding box of the target object may be adjusted to obtain a more accurate actual position of the target object, so as to perform intelligent driving control of the vehicle.

In a possible implementation, it is possible to determine the distance between the vehicle and the target object according to the center point of the bottom edge of the bounding box of the target object. The bottom edge of the bounding box of the target object is the edge of the bounding box which is close to the road. The bottom edge of the bounding box of the target object is usually parallel to the pavement of the road. The position of the bounding box of the target object may be adjusted according to the position of the edge of the free space corresponding to the bottom edge of the bounding box of the target object.

As shown in FIG. 2, the edge where the tires of the car are located is the bottom edge of the bounding box, and the edge of the free space corresponding to the bottom edge of the bounding box is parallel to the bottom edge of the bounding box. The horizontal position and/or vertical position of the bounding box of the target object may be adjusted according to the coordinates of the pixels on the edge corresponding to the bottom edge of the bounding box, such that the position of the target object identified by the adjusted bounding box becomes more consistent with the actual position of the target object.

Step S40: performing intelligent driving control on the vehicle according to an adjusted bounding box.

In a possible implementation, the position of the target object, which is identified by the bounding box, adjusted according to the free space, of the target object, is more consistent with the actual position of the target object. The actual position of the target object on the road can be determined according to the center point of the bottom edge of the adjusted bounding box of the target object. The distance between the target object and the vehicle may be calculated according to the actual position of the target object and the actual position of the vehicle.

Intelligent driving control may include: automatic driving control, or assisted driving control, and switchover therebetween. Intelligent driving control may include automatic navigation driving control, autonomous driving control, manually intervened automatic driving control, and the like. In intelligent driving control, the distance between the target object in the travelling direction of the vehicle and the vehicle is very important for the driving control. The actual position of the target object may be determined according to the adjusted bounding box, and the corresponding intelligent driving control may be performed on the vehicle according to the actual position of the target object. The present disclosure does not limit the control content and control method of the intelligent driving control.

In the present embodiment, a video stream of a road image of a scenario where the vehicle is located is collected by a vehicle-mounted camera of a vehicle; a target object is detected in the road image to obtain a bounding box of the target object; a free space of the vehicle is determined in the road image; the bounding box of the target object is adjusted according to the free space; and intelligent driving control is performed on the vehicle according to an adjusted bounding box. The bounding box, adjusted according to the free space, of the target object may identify the position of the target object more accurately, and may be used to determine the actual position of the target object more accurately, so as to perform intelligent driving control on the vehicle more precisely.

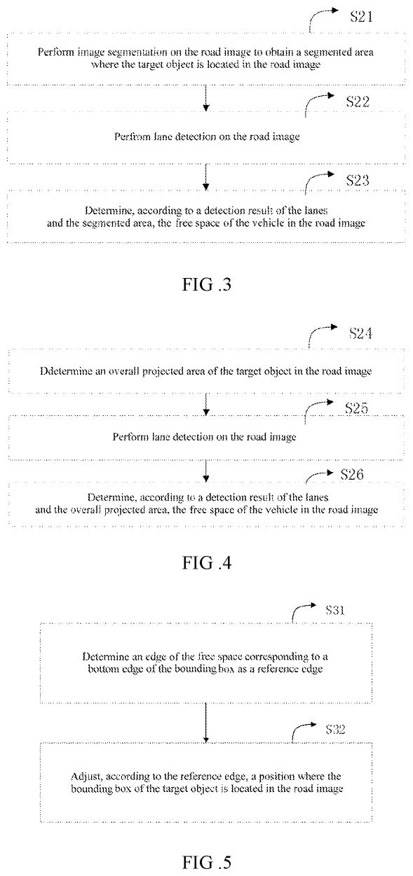

FIG. 3 shows a flow chart of Step S20 in the vehicle intelligent driving control method according to an embodiment of the present disclosure. As shown in FIG. 3, step S20 in the vehicle intelligent driving control method comprises:

Step S21: performing image segmentation on the road image to obtain a segmented area where the target object in the road image is located.

In a possible implementation, a contour line of a target object may be identified in a sample image. In a case that two target objects occlude each other, a contour line of an unoccluded part of each target object may be identified. Sample images identified with the contour lines of the target objects may be used to train a first image segmentation neural network, to obtain the first image segmentation neural network that can be used for image segmentation. Road images may be input to the trained first image segmentation neural network to obtain the segmented area where each target object is located. In a case that the target object is a vehicle, the segmented area of the vehicle obtained by the first image segmentation neural network is a silhouette of the vehicle itself. The segmented area of each target object obtained by the first image segmentation neural network is a complete silhouette of each target area, and a complete segmented area of the target object may be obtained.

In a possible implementation, the target object may be identified together with the pavement occupied by the target object in a sample image. In a case that two target objects occlude each other, the pavement occupied by the unoccluded part of each target object may be identified. Sample images identified with the target objects and the pavements occupied by the target objects may be used to train a second image segmentation neural network, to obtain the second image segmentation neural network that can be used for image segmentation. Road images may be input to the second image segmentation neural network to obtain the segmented area where each target object is located. In a case that the target object is a vehicle, the segmented area of the vehicle obtained by the second image segmentation neural network is a silhouette of the vehicle itself and the area of the pavement occupied by the vehicle. The segmented area of the target object obtained by the second image segmentation neural network includes the area of the pavement occupied by the target object, so that the free space obtained according to the segmentation result of the target object is more accurate.

Step S22: performing lane detection on the road image.

In a possible implementation, sample images identified with lanes may be used to train a lane recognition neural network, to obtain a trained lane recognition neural network. Road images may be input to the trained lane recognition neural network to recognize the lanes. The lanes may include various types of lanes such as single solid lines and double solid lines. The present disclosure does not limit the types of the lane lines.

Step S23: determining, according to a detection result of the lane and the segmented area, the free space of the vehicle in the road image.

In a possible implementation, the road area in the urban road image may be determined according to the lanes. The area other than the segmented area of the vehicle in the road area may be determined as the free space.

In a possible implementation, it is possible to determine a road area in the road image according to the two outermost lanes. The segmented area of the vehicle may be removed from a determined road area to obtain a free space.

In a possible implementation, it is also possible to determine different lanes according to each lane line, and to determine, in the road image, the road areas corresponding to the lanes, respectively. The segmented areas of the vehicle may be removed from each road area to obtain the free space corresponding to each lane area.

In the present embodiment, the road image is subjected to image segmentation to obtain a segmented area where the target object in the road image is located; a lane detection is performed on the road image; and the free space of the vehicle in the road image is determined according to a detection result of the lane and the segmented area. After the segmented area where the target object is located is obtained by image segmentation, the road area is determined according to the lanes. The free space obtained after removing the segmented area from the road area may accurately reflect the actual occupancy of the target object on the road. The free space obtained may be utilized to adjust the bounding box of the target object, so that the bounding box of the target object may identify the actual position of the target object more accurately, and is used for intelligent driving control of the vehicle.

FIG. 4 shows a flow chart of step S20 in the vehicle intelligent driving control method according to an embodiment of the present disclosure. As shown in FIG. 4, step S20 in the vehicle intelligent driving control method comprises:

Step S24: determining an overall projected area of the target object in the road image.

In a possible implementation, the overall projected area of the target object includes a projected area of the occluded part of the target object and a projected area of the unoccluded part of the target object. The target object may be recognized in the road image. In a case that the target object is occluded, the target object may be recognized according to the unoccluded part. According to the recognized partial target object that is not occluded, the actual width to length ratio preset for the target object and other information, it is possible to complement and obtain the partial target object that is occluded. According to the partial target object that is not occluded and the complemented partial target object that is occluded, the overall projected area of each target object on the road is determined in the road image.

Step S25: performing lane detection on the road image.

In a possible implementation, the description of step S25, which is the same as that of step S22 in the above-mentioned embodiment, will not be repeated.

Step S26: determining, according to a detection result of the lane and the overall projected area, the free space of the vehicle in the road image.

In a possible implementation, it is possible to determine the free space of the vehicle according to the overall projected area of each target object. It is possible to determine a road area in the road image according to the two outermost lane lines. The overall projected area of each target object may be removed from a determined road area to obtain the free space of the vehicle.

In the present embodiment, an overall projected area of the target object in the road image is determined; lane detection is performed on the road image; and the free space of the vehicle in the road image is determined according to a detection result of the lane and the overall projected area. The free space determined according to the overall projected area of the target object may accurately reflect the actual position of each target object.

In a possible implementation, the target object is a vehicle, and the bounding box of the target object is a bounding box of a front portion or rear portion of the vehicle.

In a possible implementation, in a case that the target object is a vehicle from the opposite direction, the bounding box of the vehicle may be the bounding box of the front portion of the vehicle. In a case that the target object is a vehicle in front, the bounding box of the vehicle may be the bounding box of the rear portion of the vehicle.

FIG. 5 shows a flow chart of step S30 in the vehicle intelligent driving control method according to an embodiment of the present disclosure. As shown in FIG. 5, step S30 in the vehicle intelligent driving control method comprises:

Step S31: determining an edge of the free space corresponding to a bottom edge of the bounding box as a reference edge.

In a possible implementation, the bottom edge of the bounding box of the target object is an edge of the bounding box where the target object is in contact with the road pavement. The edge of the free space corresponding to the bottom edge of the bounding box may be an edge of the free space parallel to the bottom edge of the bounding box. For example, in a case that the target object is a vehicle in front, the reference edge is an edge of the free space corresponding to the rear portion of the vehicle. As shown in FIG. 2, the edge of the free space, which is corresponding to the bottom edge of the bounding box, is the reference edge.

Step S32: adjusting, according to the reference edge, a position where the bounding box of the target object is located in the road image.

In a possible implementation, it is possible to determine the position of the center point of the reference edge. The bounding box may be adjusted such that the center point of the bottom edge of the bounding box coincides with the center point of the reference edge. The position of the bounding box may also be adjusted according to positions of pixels on the reference edge.

In a possible implementation, step S32 comprises:

determining, in an image coordinate system, first coordinate values of pixels on the reference edge along a height direction of the target object;

calculating an average value of the first coordinate values to obtain a first position average value; and

adjusting, in the height direction of the target object, the position where the bounding box of the target object is located in the road image, according to the first position average value.

In a possible implementation, in an image coordinate system, the width direction of the target object may serve as the X-axis direction, while the height direction of the target object serves as the positive direction of Y-axis. The height direction of the target object is the direction away from the ground. The width direction of the target object is the direction parallel to the ground plane. In the road image, the edge of the free space may be jagged or in another shape. It is possible to determine the first coordinate values of pixels on the reference edge along the Y-axis direction. The first position average value of the first coordinate value of each pixel may be calculated, and the position of the bounding box in the height direction of the target object may be adjusted according to the calculated first position average value.

In a possible implementation, step S32 comprises:

determining, in an image coordinate system, second coordinate values of pixels on the reference edge along a width direction of the target object;

calculating an average value of the second coordinate values to obtain a second position average value; and adjusting, in the width direction of the target object, the position of the bounding box of the target object in the road image, according to the second position average value.

In a possible implementation, it is possible to determine the second coordinate values of pixels on the reference edge along the X-axis direction. After an average value of the second coordinate values is calculated to obtain a second position average value, the position of the bounding box in the width direction of the target object may be adjusted according to the second position average value.

In a possible implementation, according to demands, it is possible to only adjust the position of the bounding box in the height or width direction of the target object, or to adjust the position of the bounding box in the height direction and in the width direction of the target object at the same time.

In the present embodiment, an edge of the free space corresponding to a bottom edge of the bounding box, is determined as a reference edge; and a position of the bounding box of the target object in the road image is adjusted according to the reference edge. The position of the bounding box adjusted according to the reference edge enables the position of the target object identified by the bounding box to be more approximate the actual position.

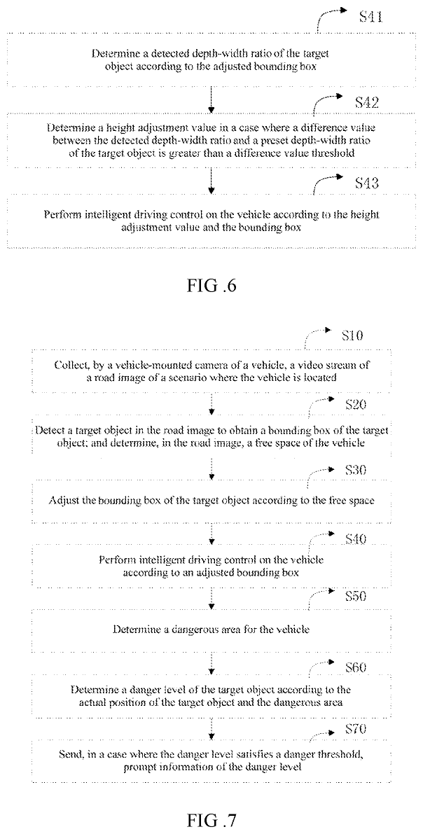

FIG. 6 shows a flow chart of step S40 in the vehicle intelligent driving control method according to an embodiment of the present disclosure. As shown in FIG. 6, step S40 in the vehicle intelligent driving control method comprises:

step S41: determining a detected depth-width ratio of the target object according to the adjusted bounding box.

In a possible implementation, the road may include uphill roads and downhill roads. In a case that the target object is on an uphill road or a downhill road, the actual position of the target object may be determined according to the bounding box of the target object. In a case that the target object is on an uphill road or a downhill road, the detected depth-width ratio of the target object is different from the normal depth-width ratio in a case that the target object is on a flat road. Therefore, in order to reduce or even avoid the deviation of the actual position of the target object, the detected depth-width ratio of the target object may be calculated according to the adjusted bounding box.

Step S42: determining a height adjustment value in the case where a difference value between the detected depth-width ratio and a preset depth-width ratio of the target object is greater than a difference value threshold.

In a possible implementation, the detected depth-width ratio of the target object may be compared with the actual depth-width ratio, to determine a height value used to adjust the position of the bounding box in the height direction. In a case that the detected depth-width ratio is greater than the actual depth-width ratio, it can be considered that the position of the target object is higher than the plane where the vehicle is located, and that the target object may be on an uphill road. At this time, the actual position of the target object may be adjusted according to the determined height value.

In a case that the detected depth-width ratio is less than the actual depth-width ratio, it can be considered that the position of the target object is lower than the plane where the vehicle is located, and the target object may be on a downhill road. The height adjustment value may be determined according to the difference value between the detected depth-width ratio and the actual depth-width ratio, and the bounding box of the target object may be adjusted according to the determined height adjustment value. The difference value between the detected depth-width ratio and the actual depth-width ratio may be proportional to the height adjustment value.

Step S43: performing intelligent driving control on the vehicle according to the height adjustment value and the bounding box.

In a possible implementation, the height adjustment value may be used to indicate the height value of the target object on the road relative to the plane where the vehicle is located. The detection position of the target object may be determined according to the center point of the bottom edge of the bounding box. It is possible to determine the actual position of the target object on the road, according to the height adjustment value and the determined detection position.

In the present embodiment, a detected depth-width ratio of the target object is determined according to the adjusted bounding box; a height adjustment value is determined in the case where a difference value between the detected depth-width ratio and a preset depth-width ratio of the target object is greater than a difference value threshold; and intelligent driving control is performed on the vehicle according to the height adjustment value and the bounding box. It is possible to determine, according to the detected depth-width ratio of the target object and the actual depth-width ratio, whether the target object is on an uphill road or a downhill road, so as to avoid the deviation of the actual position determined according to the bounding box of the target object in a case that the target object is on the uphill road or the downhill road.

In a possible implementation, the step S40 comprises:

determining, according to the adjusted bounding box, an actual position of the target object on the road with a plurality of homography matrices of the vehicle-mounted camera, wherein each homography matrix has a different calibrated distance range.

In a possible implementation, the homography matrix may be used to express the perspective transformation between a plane in the real world and other images. The homography matrix of the vehicle-mounted camera may be constructed based on the environment where the vehicle is located, and a plurality of homography matrices with different calibrated distance ranges may be determined as required. After the corresponding positions of the ranging points in the image are mapped to the environment where the vehicle is located, the distance between the target object and the vehicle may be determined. Based on the homography matrix, it is possible to obtain the distance information between the ranging point and the target object in the image captured by the vehicle. The homography matrix may be constructed based on the environment where the vehicle is located prior to ranging. For example, a monocular camera configured for an automatic vehicle may be used to capture a real road image, and a point set on the road image and a point set on the real road that corresponds to the point set on the image may be used to construct a homography matrix. The specific method may comprise: 1. Establishing a coordinate system: a vehicle body coordinate system is established by taking the left front wheel of the automatic vehicle as the origin, the right direction of the driver's view as the positive direction of the X axis, and the forward direction as the positive direction of the Y axis. 2. Selecting points: points in the vehicle body coordinate system are selected to obtain a set of selected points, e.g., (0,5), (0,10), (0,15), (1.85,5), (1.85,10), (1.85,15), where the unit of each point is meter. According to demands, farther points may also be selected. 3. Marking: the selected points are marked on the real pavement to obtain the real point set. 4. Calibration: a calibration board and a calibration program are used to obtain the corresponding pixel position of the real point set in the captured image. 5. A homography matrix is generated according to the corresponding pixel positions.

In a possible implementation, according to demands, the homography matrix may be constructed according to different distance ranges. For example, a homography matrix may be constructed with a distance range of 100 meters, or a homography matrix may be constructed with a range of 10 meters. The narrower the distance range, the higher the accuracy of the distance determined according to the homography matrix. Based on a plurality of the calibrated homography matrices, it is possible to obtain accurate actual distance of the target object.

In the present embodiment, according to the adjusted bounding box, the actual position of the target object on the road is determined by means of a plurality of homography matrices; and each homography matrix has a different calibrated distance range. With a plurality of homography matrices, more accurate actual distance of the target object may be obtained.

FIG. 7 shows a flow chart of the vehicle intelligent driving control method according to an embodiment of the present disclosure. As shown in FIG. 7, the vehicle intelligent driving control method further comprises:

Step S50: determining a dangerous area of the vehicle;

Step S60: determining a danger level of the target object according to the actual position of the target object and the dangerous area; and

Step S70: sending, in the case where the danger level satisfies a danger threshold, prompt information of danger level.

In a possible implementation, a given area in the forward direction of the vehicle may be determined as a dangerous area. In the driving direction of the vehicle, an area in front of the vehicle that has a given length and a given width may be determined as a dangerous area. For example, a sector area in front of the vehicle with the center of the hood of the vehicle as the center of a circle and with a radius of 5 meters is determined as a dangerous area, or an area right in front of the vehicle with a length of 5 meters and a width of 3 meters is determined as a dangerous area. The size and shape of the dangerous area may be determined as required.

In a possible implementation, in a case that the actual position of the target object is within the dangerous area, the danger level of the target object may be determined as a serious danger. In a case that the actual position of the target object is out of the dangerous area, the danger level of the target object may be determined as a general danger.

In a possible implementation, in a case that the actual position of the target object is out of the dangerous area, and the target object is not occluded, the danger level of the target object may be determined as a general danger.

In a case that the actual position of the target object is out of the dangerous area, and the target object is occluded, the danger level of the target object may be determined as no danger.

In a possible implementation, corresponding prompt information of danger level may be sent according to the danger level for the target object. The prompt information of danger level may be expressed in different forms, such as a voice, vibration, light, and a text. The present disclosure does not limit the specific content and form of expression of the prompt information of danger level.

In a possible implementation, determining a danger level of the target object according to the actual position of the target object and the dangerous area comprises:

determining a first danger level of the target object according to the actual position of the target object and the dangerous area;

determining, in the case where the first danger level of the target object is a highest danger level, an adjacent position of the target object in an adjacent image of the road images in the video stream; and

determining the danger level of the target object according to the adjacent position and the actual position of the target object.

In a possible implementation, the road image captured by the vehicle may be an image in the video stream. In a case that the danger level of the target object is determined as a serious danger, it is possible to determine, according to the current road image and the image before the current road image, the adjacent position of the target object in the image before the current road image by the method in the above-mentioned embodiment of the present disclosure. The overlapping degree of the target objects in the current road image and in the image before the current road image may also be calculated. In a case that the calculated overlapping degree is greater than the overlapping degree threshold, the adjacent position of the target object can be determined. It is also possible to calculate the historical distance between the target object and the vehicle in the image before the current road image, and calculate the distance difference value between the historical distance and the distance between the target object and the vehicle in the current road image. In a case that the distance difference value is less than the distance threshold, the adjacent position of the target object can be determined.

The danger level of the target object may be determined according to the determined adjacent position and the actual position of the target object.

In the present embodiment, a first danger level of the target object is determined according to the actual position of the target object and the dangerous area; in the case where the first danger level of the target object is a highest danger level, an adjacent position of the target object is determined in an adjacent image of the road images in the video stream; and the danger level of the target object is determined according to the adjacent position and the actual position of the target object. According to the adjacent position of the target object in the adjacent image and the actual position of the target object, the danger level of the target object can be determined more accurately.

In a possible implementation, the method further comprises:

obtaining collision time according to a distance between the target object and the vehicle, movement information of the target object, and movement information of the vehicle;

determining collision warning information according to the collision time and a time threshold; and

sending the collision warning information.

In a possible implementation, the time of a collision between the target object and the vehicle may be calculated according to the distance from the target object to the vehicle, the moving speed and the moving direction of the target object, and the moving speed and the moving direction of the vehicle. It is possible to preset a time threshold, and to obtain collision warning information according to the time threshold and the collision time. For example, the time threshold is preset as 5 seconds. In a case that the calculated time of the collision between the target vehicle in front and the current vehicle is less than 5 seconds, it may be considered that if the target vehicle collides with the current vehicle, the driver of the vehicle may not be able to make a timely response and a danger occurs, there is a need to send the collision warning information. The collision warning information may be sent in different express forms, such as a sound, vibration, light, and a text and the like. The present disclosure does not limit the specific content and express form of the collision warning information.

In the present embodiment, the collision time may be calculated according to the distance between the target object and the vehicle, the movement information of the target object, and the movement information of the vehicle; the collision warning information is determined according to the collision time and the time threshold; and the collision warning information is sent. The collision warning information obtained according to the actual distance between the target object and the vehicle and the movement information can be applied to the field of safe driving in the vehicle intelligent driving, so as to improve the safety.

In a possible implementation, sending the collision warning information comprises:

sending the collision warning information in the case where there is no transmission record of the collision warning information of the target object in sent collision warning information; and/or not sending the collision warning information in the case where there is a transmission record of the collision warning information of the target object in sent collision warning information.

In a possible implementation, after collision warning information for a target object is generated from the vehicle, it is possible to look up whether there is collision warning information for this target object in the transmission record of the collision warning information that have been sent; if yes, the collision warning information will not be sent. This may improve the user experience.

In a possible implementation, sending the collision warning information comprises:

acquiring driving status information of the vehicle, wherein the driving status information includes braking information and/or steering information; and

determining, in the case where it is determined according to the driving status information that the vehicle has not performed corresponding braking and/or steering operation, whether or not to send the collision warning information according to driving status information.

In a possible implementation, in a case that a collision may occur if the vehicle moves according to the current movement information, the driver of the vehicle may perform operations such as braking for deceleration, and/or steering. The braking information and steering information of the vehicle may be obtained according to driving status information of the vehicle. In a case that the braking information and/or steering information are obtained according to driving status information, it is possible not to send or to stop sending the collision warning information.

In the present embodiment, driving status information of the vehicle is acquired, wherein driving status information includes braking information and/or steering information; and whether or not to send the collision warning information is determined according to driving status information. According to driving status information, it may be determined not to send or to stop sending the collision warning information, so as to humanize the sending of the collision warning information and to improve the user experience.

In a possible implementation, sending the collision warning information comprises:

acquiring driving status information of the vehicle, wherein the driving status information includes braking information and/or steering information; and

sending the collision warning information in the case where it is determined according to the driving status information that the vehicle has not performed corresponding braking and/or steering operation.

In a possible implementation, the driving status information may be acquired from the CAN (Controller Area Network) bus of the vehicle. According to the driving status information, it is possible to determine whether the vehicle has performed the corresponding operations of braking and/or steering. If it is determined according to the driving status information that the driver or the intelligent driving system of the vehicle has performed the related operation, the collision warning information may not be sent, so as to improve the user experience.

In a possible implementation, the target object is a vehicle, and the method further comprises:

detecting a vehicle license plate and/or a vehicle logo of the vehicle in the road image;

determining a reference distance of the target object according to detection results of the vehicle license plate and/or the vehicle logo; and

adjusting the distance between the target object and the vehicle according to the reference distance.

In a possible implementation, on the road, occlusion between vehicles may lead to such a case that the bounding box of the vehicle in front is not the bounding box of the whole vehicle, or the two vehicles are so close to each other that the rear portion of the vehicle in font is in the blind area of the vehicle-mounted camera and is invisible in the road image, or in other similar situations, the bounding box of the vehicle cannot accurately box the position of the vehicle in front, because there is a large error in the distance between the target vehicle and the current vehicle calculated according to the bounding box. At this time, a neural network may be used to recognize the bounding boxes of the vehicle license plate and/or the vehicle logo of the vehicle, and to correct the distance between the target vehicle and the current vehicle by the bounding boxes of the vehicle license plate and/or the vehicle logo.

Sample images identified with the vehicle license plate and/or vehicle logo may be used to train a vehicle identification neural network. Road images may be input to the trained vehicle identification neural network to obtain the vehicle license plate and/or vehicle logo of the vehicle. As shown in FIG. 2, the vehicle license plate at the rear portion of the vehicle in front is boxed by a rectangular box. The vehicle logo may be a mark of the vehicle type at the rear portion or the front portion of the vehicle. The bounding box of the vehicle logo is not shown in FIG. 2. The vehicle logo is usually arranged at a position close to the vehicle license plate, e.g., arranged at an upper position adjacent to the vehicle license plate.

There may be a difference between the reference distance of the target object that is determined according to the detection results of the vehicle license plate and/or the vehicle logo, and the distance between the target object and the vehicle determined according to the rear portion or the entirety of the target object. The reference distance may be larger or smaller than the distance determined according to the rear portion or the entirety of the target object.

In a possible implementation, adjusting the distance between the target object and the vehicle according to the reference distance comprises:

adjusting, in the case where a difference value between the reference distance and the distance between the target object and the vehicle is greater than a difference value threshold, the distance between the target object and the vehicle to the reference distance, or

calculating a difference value between the distance between the target object and the vehicle and the reference distance, and determining, according to the difference value, the distance between the target object and the vehicle.

In a possible implementation, the vehicle license plate and/or vehicle logo of the vehicle may be used to determine the reference distance between the target object and the vehicle. The difference value threshold may be preset as required. In the case where the difference value between the reference distance and the distance between the target object and the vehicle is greater than the difference value threshold, the distance between the target object and the vehicle may be adjusted to the reference distance. In a case that the difference between the reference distance and the calculated distance between the target object and the vehicle is relatively larger, an average value of the two distances may be calculated, and the calculated average value is determined as the adjusted distance between the target object and the vehicle.

In the present embodiment, the recognition information of the target object is detected in the road image, wherein the recognition information includes a vehicle license plate and/or a vehicle logo; a reference distance of the target object is determined according to the recognition information; and the distance between the target object and the vehicle is adjusted according to the reference distance. Adjusting the adjusted distance between the target object and the vehicle according to the recognition information of the target object renders the adjusted distance more accurate.

In a possible implementation, adjusting the distance between the target object and the vehicle according to the reference distance comprises:

adjusting the distance between the target object and the vehicle to the reference distance, or

calculating a difference value between the distance between the target object and the vehicle and the reference distance, and determining, according to the difference value, the distance between the target object and the vehicle.

In a possible implementation, adjusting the distance between the target object and the vehicle according to the reference distance comprises: directly adjusting the distance between the target object and the vehicle to the reference distance, or calculating the difference between them. If the reference distance is larger than the distance between the target object and the vehicle, the difference may be added to the distance between the target object and the vehicle. If the reference distance is smaller than the distance between the target object and the vehicle, the difference may be subtracted from the distance between the target object and the vehicle.

It is understandable that the above-mentioned method embodiments of the present disclosure may be combined with one another to form a combined embodiment without departing from the principle and the logics, which, due to limited space, will not be repeatedly described in the present disclosure.

In addition, the present disclosure further provides a vehicle intelligent driving control device, an electronic apparatus, a computer readable storage medium, and a program, which are all capable of realizing any one of the vehicle intelligent driving control methods provided in the present disclosure. For the corresponding technical solution and descriptions which will not be repeated, reference may be made to the corresponding descriptions of the method.

A person skilled in the art may understand that, in the foregoing method according to specific embodiments, the order of describing the steps does not means a strict order of execution that imposes any limitation on the implementation process. Rather, a specific order of execution of the steps should depend on the functions and possible inherent logics of the steps.

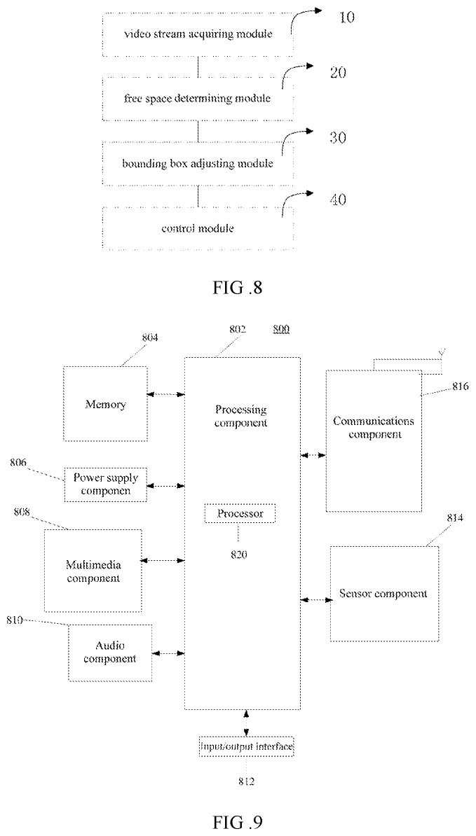

FIG. 8 shows a block diagram of the vehicle intelligent driving control device according to an embodiment of the present disclosure. As shown in FIG. 8, the vehicle intelligent driving control device comprises:

a video stream acquiring module 10, configured to collect, by a vehicle-mounted camera of a vehicle, a video stream of a road image of a scenario where the vehicle is located;

a free space determining module 20, configured to detect a target object in the road image to obtain a bounding box of the target object; and determine, in the road image, a free space of the vehicle;

a bounding box adjusting module 30, configured to adjust the bounding box of the target object according to the free space; and

a control module 40, configured to perform intelligent driving control on the vehicle according to an adjusted bounding box.

In a possible implementation, the free space determining module comprises:

an image segmentation sub-module, configured to perform image segmentation on the road image to obtain a segmented area where the target object in the road image is located;

a first lane detecting sub-module, configured to perform lane detection on the road image; and

a first free space determining sub-module, configured to determine, according to a detection result of the lane and the segmented area, the free space, which is in the road image, of the vehicle.

In a possible implementation, the free space determining module comprises:

an overall projected area determining sub-module, configured to determine an overall projected area, which is in the road image, of the target object;

a second lane detecting sub-module, configured to perform lane detection on the road image; and

a second free space determining sub-module, configured to determine, according to a detection result of the lane and the overall projected area, the free space, which is in the road image, of the vehicle.

In a possible implementation, the target object is a vehicle, and the bounding box of the target object is a bounding box of a front portion or rear portion of the vehicle.

In a possible implementation, the bounding box adjusting module comprises:

a reference edge determining sub-module, configured to determine an edge of the free space, which is corresponding to a bottom edge of the bounding box, as a reference edge; and

a bounding box adjusting sub-module, configured to adjust, according to the reference edge, a position where the bounding box of the target object is located in the road image.

In a possible implementation, the bounding box adjusting sub-module is configured to:

determine, in an image coordinate system, first coordinate values of pixels included in the reference edge along a height direction of the target object;

calculate an average value of the first coordinate values to obtain a first position average value; and

adjust, in the height direction of the target object, the position where the bounding box of the target object is located in the road image, according to the first position average value.

In a possible implementation, the bounding box adjusting sub-module is further configured to:

determine, in an image coordinate system, second coordinate values of pixels included in the reference edge along a width direction of the target obj ect;

calculate an average value of the second coordinate values to obtain a second position average value; and

adjust, in the width direction of the target object, the position where the bounding box of the target object is located in the road image. according to the second position average value.

In a possible implementation, the control module comprises:

a detected depth-width ratio determining sub-module, configured to determine a detected depth-width ratio of the target object according to the adjusted bounding box;

a height adjustment value determining sub-module, configured to determine a height adjustment value in the case where a difference value between the detected depth-width ratio and a preset depth-width ratio of the target object is greater than a difference value threshold; and

a first control sub-module, configured to perform intelligent driving control on the vehicle according to the height adjustment value and the bounding box.

In a possible implementation, the control module comprises:

an actual position determining sub-module, configured to determine, according to the adjusted bounding box, an actual position of the target object, which is on the road, by means of a plurality of homography matrices of the vehicle-mounted camera, wherein each homography matrix has a different calibrated distance range; and

a second control sub-module, configured to perform the intelligent driving control on the vehicle according to the actual position of the target object, which is on the road.

In a possible implementation, the device further comprises:

a dangerous area determining module, configured to determine a dangerous area of the vehicle;

a danger level determining module, configured to determine a danger level of the target object according to the actual position of the target object and the dangerous area; and

a first prompt information sending module, configured to send, in the case where the danger level satisfies a danger threshold, prompt information of the danger level.

In a possible implementation, the danger level determining module comprises:

a first danger level determining sub-module, configured to determine a first danger level of the target object according to the actual position of the target object and the dangerous area;

an adjacent position determining sub-module, configured to determine, in the case where the first danger level of the target object is a highest danger level, an adjacent position of the target object, in an adjacent image of the road images in the video stream; and

a second danger level determining sub-module, configured to determine the danger level of the target object according to the adjacent position and the actual position of the target object.

In a possible implementation, the device further comprises:

a collision time acquiring module, configured to obtain collision time according to a distance between the target object and the vehicle, movement information of the target object, and movement information of the vehicle;

a collision warning information determining module, configured to determine collision warning information according to the collision time and a time threshold; and

a second prompt information sending module, configured to send the collision warning information.

In a possible implementation, the second prompt information sending module comprises:

a second prompt information sending sub-module, configured to send the collision warning information in the case where there is no transmission record of the collision warning information of the target object in sent collision warning information; and/or not send the collision warning information in the case where there is a transmission record of the collision warning information of the target object in sent collision warning information.

In a possible implementation, the second prompt information sending module comprises:

a driving status information acquiring sub-module, configured to acquire driving status information of the vehicle, wherein the driving status information includes braking information and/or steering information; and

a third prompt information sending sub-module, configured to send the collision warning information in the case where it is determined according to the driving status information that the vehicle has not performed corresponding braking and/or steering operation.

In a possible implementation, the device further comprises a distance determining device, configured to determine a distance between a target object and the vehicle, and the distance determining device comprises:

a vehicle license plate/vehicle logo detecting sub-module, configured to detect a vehicle license plate and/or a vehicle logo of the vehicle in the road image;

a reference distance determining sub-module, configured to determine a reference distance of the target object according to detection results of the vehicle license plate and/or the vehicle logo; and

a distance determining sub-module, configured to adjust the distance between the target object and the vehicle according to the reference distance.

In a possible implementation, the distance determining sub-module is configured to:

adjust, in the case where a difference value between the reference distance and the distance between the target object and the vehicle is greater than a difference value threshold, the distance between the target object and the vehicle to the reference distance, or

calculate a difference value between the distance between the target object and the vehicle and the reference distance, and determine, according to the difference value, the distance between the target object and the vehicle.

In some embodiments, functions of or modules included in the device provided in the embodiments of the present disclosure may be configured to execute the method described in the foregoing method embodiments. For specific implementation of the functions or modules, reference may be made to descriptions of the foregoing method embodiments. For brevity, details are not described here again.

The embodiments of the present disclosure further propose a computer readable storage medium having computer program instructions stored thereon, wherein the computer program instructions, when executed by a processor, implement the method above. The computer readable storage medium may be a non-volatile computer readable storage medium.

The embodiments of the present disclosure further propose an electronic apparatus, comprising: a processor; and a memory configured to store processor-executable instructions; wherein the processor is configured to carry out the method above.

The electronic apparatus may be provided as a terminal, a server, or an apparatus in other forms.

FIG. 9 shows a block diagram for the electronic apparatus 800 according to an exemplary embodiment of the present disclosure. For example, the electronic apparatus 800 may be a mobile phone, a computer, a digital broadcasting terminal, a message transmitting and receiving apparatus, a game console, a tablet apparatus, medical equipment, fitness equipment, a personal digital assistant, and other terminals.

Referring to FIG. 9, the electronic apparatus 800 may include one or more components of: a processing component 802, a memory 804, a power supply component 806, a multimedia component 808, an audio component 810, Input/Output (I/O) interface 812, a sensor component 814, and a communication component 816.

The processing component 802 is configured usually to control overall operations of the electronic apparatus 800, such as the operations associated with display, telephone calls, data communications, camera operations, and recording operations. The processing component 802 can include one or more processors 820 configured to execute instructions to perform all or part of the steps included in the above-described methods. In addition, the processing component 802 may include one or more modules configured to facilitate the interaction between the processing component 802 and other components. For example, the processing component 802 may include a multimedia module configured to facilitate the interaction between the multimedia component 808 and the processing component 802.

The memory 804 is configured to store various types of data to support the operation of the electronic apparatus 800. Examples of such data include instructions for any applications or methods operated on or performed by the electronic apparatus 800, contact data, phonebook data, messages, pictures, video, etc. The memory 804 may be implemented using any type of volatile or non-volatile memory apparatus, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 is configured to provide power to various components of the electronic apparatus 800. The power component 806 may include a power management system, one or more power sources, and any other components associated with the generation, management, and distribution of power in the electronic apparatus 800.

The multimedia component 808 includes a screen providing an output interface between the electronic apparatus 800 and the user. In some embodiments, the screen may include a liquid crystal display (LCD) and a touch panel (TP). If the screen includes the touch panel, the screen may be implemented as a touch screen to receive input signals from the user.

The touch panel may include one or more touch sensors configured to sense touches, swipes, and gestures on the touch panel. The touch sensors may sense not only a boundary of a touch or swipe action, but also a period of time and a pressure associated with the touch or swipe action. In some embodiments, the multimedia component 808 may include a front camera and/or a rear camera. The front camera and/or the rear camera may receive an external multimedia datum while the electronic apparatus 800 is in an operation mode, such as a photographing mode or a video mode. Each of the front camera and the rear camera may be a fixed optical lens system or may have focus and/or optical zoom capabilities.

The audio component 810 is configured to output and/or input audio signals. For example, the audio component 810 may include a microphone (MIC) configured to receive an external audio signal when the electronic apparatus 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output audio signals.

The I/O interface 812 is configured to provide an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors configured to provide status assessments of various aspects of the electronic apparatus 800. For example, the sensor component 814 may detect at least one of an open/closed status of the electronic apparatus 800, relative positioning of components, e.g., the components being the display and the keypad of the electronic apparatus 800. The sensor component 814 may further detect a change of position of the electronic apparatus 800 or one component of the electronic apparatus 800, presence or absence of contact between the user and the electronic apparatus 800, location or acceleration/deceleration of the electronic apparatus 800, and a change of temperature of the electronic apparatus 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate wired or wireless communication between the electronic apparatus 800 and other apparatus. The electronic apparatus 800 can access a wireless network based on a communication standard, such as WiFi, 2G, or 3G, or a combination thereof. In an exemplary embodiment, the communication component 816 receives a broadcast signal or broadcast associated information from an external broadcast management system via a broadcast channel. In an exemplary embodiment, the communication component 816 may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In exemplary embodiments, the electronic apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In exemplary embodiments, there is also provided a non-volatile computer readable storage medium including computer program instructions, such as those included in the memory 804, executable by the processor 820 of the electronic apparatus 800, for completing the above-described methods.

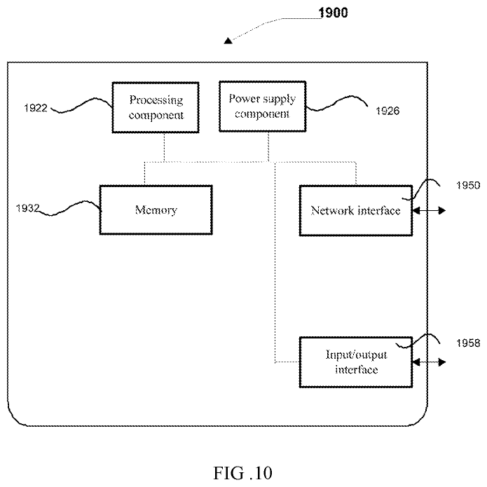

FIG. 10 is another block diagram showing an electronic apparatus 1900 according to an embodiment of the present disclosure. For example, the electronic apparatus 1900 may be provided as a server. Referring to FIG. 10, the electronic apparatus 1900 includes a processing component 1922, which further includes one or more processors, and a memory resource represented by a memory 1932 configured to store instructions such as application programs executable for the processing component 1922. The application programs stored in the memory 1932 may include one or more than one module of which each corresponds to a set of instructions. In addition, the processing component 1922 is configured to execute the instructions to execute the above-mentioned methods.

The electronic apparatus 1900 may further include a power component 1926 configured to execute power management of the electronic apparatus 1900, a wired or wireless network interface 1950 configured to connect the electronic apparatus 1900 to a network, an Input/Output (I/O) interface 1958. The electronic apparatus 1900 may be operated on the basis of an operating system stored in the memory 1932, such as Windows Server™, Mac OS X™, Unix™, Linux™ or FreeBSD™.

In exemplary embodiments, there is also provided a nonvolatile computer readable storage medium, for example, memory 1932 including computer program instructions, which are executable by the processing component 1922 of the electronic apparatus 1900, to complete the above-described methods.

The present disclosure may be a system, a method, and/or a computer program product. The computer program product may include a computer readable storage medium having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage apparatus, a magnetic storage apparatus, an optical storage apparatus, an electromagnetic storage apparatus, a semiconductor storage apparatus, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded apparatus such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing apparatuses from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing apparatus.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowcharts and/or block diagrams of methods, apparatus (systems), and computer program products according to embodiments of the present disclosure. It will be appreciated that each block of the flowcharts and/or block diagrams, and combinations of blocks in the flowcharts and/or block diagrams, can be implemented by computer readable program instructions.

These computer readable program instructions may be provided to a processor of a general purpose computer, special purpose computer, or other programmable data processing devices to produce a machine, such that the instructions, which execute via the processor of the computer or other programmable data processing devices, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing devices, or other apparatuses to cause a series of operational steps to be performed on the computer, other programmable devices or other apparatuses to produce a computer implemented process, such that the instructions which execute on the computer, other programmable devices, or other apparatuses implement the functions/acts specified in the flowchart and/or block diagram block or blocks.

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, program segment, or portion of instruction, which comprises one or more executable instructions for implementing the specified logical function(s). In some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

Although the embodiments of the present disclosure have been described above, the foregoing descriptions are exemplary but not exhaustive, and the disclosed embodiments are not limiting. For a person skilled in the art, a number of modifications and variations are obvious without departing from the scope and spirit of the described embodiments. The terms used herein are intended to provide the best explanations on the principles of the embodiments, practical applications, or technical improvements to the technologies in the market, or to make the embodiments described herein understandable to other persons skilled in the art.

What is claimed is:

1. A vehicle intelligent driving control method, wherein the method comprises:
collecting, by a vehicle-mounted camera of a vehicle, a video stream of a road image of a scenario where the vehicle is located;
detecting a target object in the road image to obtain a bounding box of the target object; and determining, in the road image, a free space of the vehicle;
adjusting the bounding box of the target object according to the free space; and
performing intelligent driving control on the vehicle according to the adjusted bounding box.

2. The method according to claim 1, wherein determining, in the road image, the free space of the vehicle comprises:
performing image segmentation on the road image to obtain a segmented area where the target object in the road image is located;
performing lane detection on the road image; and
determining, according to a detection result of the lanes and the segmented area, the free space of the vehicle in the road image.

3. The method according to claim 1, wherein determining, in the road image, the free space of the vehicle comprises:
determining an overall projected area of the target object in the road image;
performing lane detection on the road image; and
determining, according to a detection result of the lanes and the overall projected area, the free space of the vehicle in the road image.

4. The method according to claim 1, wherein the target object is a vehicle, and the bounding box of the target object is a bounding box of a front or rear portion of the vehicle.

5. The method according to claim 1, wherein adjusting the bounding box of the target object according to the free space comprises:
determining an edge of the free space corresponding to a bottom edge of the bounding box as a reference edge; and
adjusting, according to the reference edge, a position where the bounding box of the target object is located in the road image.

6. The method according to claim 5, wherein adjusting, according to the reference edge, the position where the bounding box of the target object is located in the road image comprises:
determining, in an image coordinate system, first coordinate values of pixels included in the reference edge along a height direction of the target object;
calculating an average value of the first coordinate values to obtain a first position average value; and
adjusting, in the height direction of the target object, the position where the bounding box of the target object is located in the road image, according to the first position average value.

7. The method according to claim 5, wherein adjusting, according to the reference edge, the position where the bounding box of the target object is located in the road image comprises:
determining, in an image coordinate system, second coordinate values of pixels on the reference edge along a width direction of the target object;
calculating an average value of the second coordinate values to obtain a second position average value; and
adjusting, in the width direction of the target object, the position where the bounding box of the target object is located in the road image according to the second position average value.

8. The method according to claim 1, wherein performing intelligent driving control on the vehicle according to the adjusted bounding box comprises:
determining a detected depth-width ratio of the target object according to the adjusted bounding box;
determining a height adjustment value in a case where a difference value between the detected depth-width ratio and a preset depth-width ratio of the target object is greater than a difference value threshold; and
performing intelligent driving control on the vehicle according to the height adjustment value and the bounding box.

9. The method according to claim 1, wherein performing intelligent driving control on the vehicle according to the adjusted bounding box comprises:
determining, according to the adjusted bounding box, an actual position of the target object on the road with a plurality of homography matrices of the vehicle-mounted camera, wherein each homography matrix has a different calibrated distance range; and
performing the intelligent driving control on the vehicle according to the actual position of the target object on the road.

10. The method according to claim 9, wherein the method further comprises:
determining a dangerous area for the vehicle;
determining a danger level of the target object according to the actual position of the target object and the dangerous area; and
sending, in a case where the danger level satisfies a danger threshold, prompt information of the danger level.

11. The method according to claim 10, wherein determining the danger level of the target object according to the actual position of the target object and the dangerous area comprises:
determining a first danger level of the target object according to the actual position of the target object and the dangerous area;
determining, in a case where the first danger level of the target object is a highest danger level, an adjacent position of the target object in an adjacent image of the road images in the video stream; and
determining the danger level of the target object according to the adjacent position and the actual position of the target object.

12. The method according to claim 1, wherein the method further comprises:
obtaining collision time according to a distance between the target object and the vehicle, movement information of the target object, and movement information of the vehicle;
determining collision warning information according to the collision time and a time threshold; and
sending the collision warning information.

13. The method according to claim 12, wherein sending the collision warning information comprises:
sending the collision warning information in a case where there is no transmission record of the collision warning information for the target object in the sent collision warning information; and/or not sending the collision warning information in a case where there is a transmission record of the collision warning information for the target object in the sent collision warning information.

14. The method according to claim 12, wherein sending the collision warning information comprises:
acquiring driving status information of the vehicle, wherein the driving status information includes braking information and/or steering information; and
sending the collision warning information in a case where it is determined according to the driving status information that the vehicle has not performed corresponding braking and/or steering operation.

15. The method according to claim 12, wherein a step of determining a distance between the target object and the vehicle comprises:
detecting, in the road image, a vehicle license plate and/or a vehicle logo of the vehicle;
determining a reference distance of the target object according to detection results of the vehicle license plate and/or the vehicle logo; and
adjusting the distance between the target object and the vehicle according to the reference distance.

16. The method according to claim 15, wherein adjusting the distance between the target object and the vehicle according to the reference distance comprises:
adjusting, in a case where a difference value between the reference distance and the distance between the target object and the vehicle is greater than a difference value threshold, the distance between the target object and the vehicle to the reference distance, or
calculating a difference value between the reference distance and the distance between the target object and the vehicle, and determining, according to the difference value, the distance between the target object and the vehicle.

17. A vehicle intelligent driving control device, wherein the device comprises:
a processor; and
a memory configured to store processor-executed instructions,
wherein the processor is configured to invoke the instructions stored in the memory, so as to:
collect, by a vehicle-mounted camera of a vehicle, a video stream of a road image of a scenario where the vehicle is located;
detect a target object in the road image to obtain a bounding box of the target object; and determine, in the road image, a free space of the vehicle;
adjust the bounding box of the target object according to the free space; and
perform intelligent driving control on the vehicle according to the adjusted bounding box.

18. The device according to claim 17, wherein detecting the target object in the road image to obtain the bounding box of the target object, and determining, in the road image, the free space of the vehicle comprises:
performing image segmentation on the road image to obtain a segmented area where the target object in the road image is located;
performing lane detection on the road image; and
determining, according to a detection result of the lanes and the segmented area, the free space of the vehicle in the road image.

19. The device according to claim 17, wherein detecting the target object in the road image to obtain the bounding box of the target object, and determining, in the road image, the free space of the vehicle comprises:
determining an overall projected area of the target object in the road image;
performing lane detection on the road image; and
determining, according to a detection result of the lanes and the overall projected area, the free space of the vehicle in the road image.

20. A non-transitory computer readable storage medium having computer program instructions stored thereon, wherein when the computer program instructions are executed by a processor, the processor is caused to perform the operations of:
collecting, by a vehicle-mounted camera of a vehicle, a video stream of a road image of a scenario where the vehicle is located;
detecting a target object in the road image to obtain a bounding box of the target obj ect; and determining, in the road image, a free space of the vehicle;
adjusting the bounding box of the target object according to the free space; and
performing intelligent driving control on the vehicle according to the adjusted bounding box.
